(19) United States
(12) Patent Application Publication
(10) Pub. No.: US 2015/0032815 A1
(43) Pub. Date: Jan. 29, 2015

(54) MESSAGE FORWARDING IN DATA CENTER NETWORK

(71) Applicant: Hangzhou H3C Technologies Co., LTD., Hangzhou, Zhejiang (CN)

(72) Inventor: Huifeng Chang, Haidian District (CN)

(21) Appl. No.: 14/374,201

(22) PCT Filed: Jul. 30, 2013
(86) PCT No.: PCT/CN2013/080397

§ 371 Date: Jul. 23, 2014

(30) Foreign Application Priority Data
Jul. 31, 2012 (CN) 201210269080.1

(51) Int. Cl. H04L 29/08

(52) U.S. Cl. CPC H04L 67/10
USPC 709/204

(57) ABSTRACT

A data center network comprises CORE devices which are stacked to form a stack system and an ACCESS device. Information of connection between each CORE device in the stack system and its peer ACCESS devices is recorded. Upon determining a change in the information of connection between any CORE device and its peer ACCESS devices, said CORE device is labeled with a low-forwarding-capability identifier. When transmitting a message, the ACCESS device selects a CORE device other than the CORE device labeled with a low-forwarding-capability identifier to perform the message forwarding.

### BACKGROUND

Currently, a data center network may aim to realize non-blocking, non-loop and single-layer high performance switching for example at 10 GB rate. A typical data center network may include: CORE devices and ACCESS devices, wherein the CORE devices employ a high performance switching structure to realize non-blocking switching, and the ACCESS devices realize non-blocking uplink for example at 10 GB.

In a data center network, in order to make full use of the forwarding capability of CORE devices and to realize load sharing and disaster backup among CORE devices, ACCESS devices and CORE devices may be fully connected, i.e. each of the ACCESS devices is connected to different CORE devices and the different CORE devices are interconnected.

### DESCRIPTION OF DRAWINGS

FIG. 1 is a schematic drawing of a networking of a data center network provided by an example of the present disclosure;

FIG. 2 is a flow chart of a method that is applied to the data center network of FIG. 1 provided by an example of the present disclosure;

FIG. 3 is a structural diagram of a CORE device provided by an example of the present disclosure;

FIG. 4 is a structural diagram of an ACCESS device provided by an example of the present disclosure.

### DETAILED DESCRIPTION

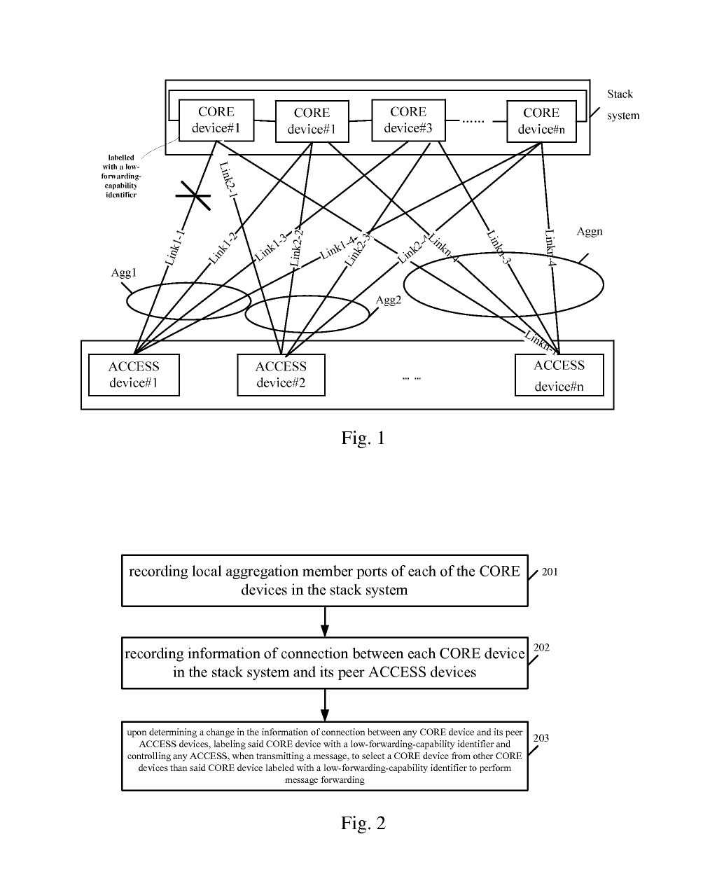

FIG. 1 is a schematic drawing of a networking of a data center network provided by an example of the present disclosure. Said data center network at least comprises CORE devices and ACCESS devices, wherein all the CORE devices form a stack system through stacking, for example, the CORE devices form an IRF system through an IRF technique, and in the data center network, the ACCESS devices are connected to the stack system through aggregate links, here, an aggregate link between an ACCESS device and the stack system is obtained by aggregating links through which the ACCESS device is connected to each of the CORE devices in the stack system, and said links through which the ACCESS device is connected to each of the CORE devices in the stack system are member links of said aggregate link.

FIG. 2 is a flow chart of a method provided by an example. The method is applied to the data center network of FIG. 1.

Based on this, as shown in FIG. 2, an ACCESS device can perform the following blocks:

Block 201, recording local aggregation member ports of each of the CORE devices in the stack system.

In the present example, the stack system is connected to an ACCESS device through an aggregate link, but in practical application, said aggregate link is obtained by aggregating links through which the ACCESS device is connected to each of the CORE devices in the stack system, and said aggregated links are called member links of the aggregate link. For example, in the networking shown in FIG. 1, the stack system is connected to ACCESS device #1 through an aggregate link (labeled as Agg1), said Agg1 being formed by aggregating Link1-1˜Link1-4 through which the ACCESS device #1 is connected to CORE device #1˜CORE device #4, and Link1-1˜Link1-4 being member links of Agg1.

Based on this, with respect to an aggregate link between the stack system and an ACCESS device, from the perspective of the stack system, ports of member links in said aggregate link are distributed on different CORE devices in the stack system respectively, while as for each CORE device, it may call the port distributed thereon as a local aggregate member port.

Taking the networking shown in FIG. 1 as an example, if ACCESS device #1, ACCESS device #2 and ACCESS device #n are connected to the stack system through aggregate link 1 (labeled as Agg1), aggregate link 2 (labeled as Agg2) and Aggregate link 3 (labeled as Aggn), respectively, while one of other ACCESS devices may be connected to the stack system through an aggregate link or through only one link, and the present disclosure does not specifically limit this; wherein, Agg1 is formed by aggregating Link1-1˜Link1-4 through which the ACCESS device #1 is connected to CORE device #1˜CORE device #4, i.e. Link1-1˜Link1-4 are member links of Agg1, Agg2 is formed by aggregating Link2-1˜Link2-4 through which the ACCESS device #2 is connected to CORE device #1˜CORE device #4, i.e. Link2-1˜Link2-4 are member links of Agg2, and Aggn is formed by aggregating Linkn-1˜Linkn-4 through which the ACCESS device #n is connected to CORE device #1˜CORE device #4, i.e. Linkn-1˜Linkn-4 are member links of Aggn, then, the following ports present on the CORE device #1 are local aggregate member ports: a port of the CORE device #1 on which a member link, i.e. Link1-1, of Agg1 is distributed, a port of the CORE device #1 on which a member link, i.e. Link2-1, of Agg2 is distributed, and a port of the CORE device #1 on which a member link, i.e. Linkn-1, of Aggn is distributed (herein the CORE device #1 in the stack system is taken as an example, while as for the rest CORE devices, the similar principle applies).

In addition, in the present example, each ACCESS device may have more than one link connection with a same CORE device depending on the bandwidth requirement, in this case, when the ACCESS device aggregates links connected to the CORE devices in the stack system, it may aggregate all links connected to each of the CORE devices to form an aggregate link. For example, in the networking shown in FIG. 1, suppose that in FIG. 1, the Link1-1 between the ACCESS device #1 and CORE device #1 is replaced by Link1-1-1 and Link1-1-2, namely, the ACCESS device #1 is connected to the CORE device #1 through two links, i.e. Link 1-1-1 and Link 1-1-2, simultaneously, while the links between the ACCESS device #1 and CORE device #2˜CORE device #4 are Link 1-2, Link 1-3 and Link 1-4, thus in the present example, the ACCESS device #1 aggregates Link1-1-1, Link 1-1-2, Link1-2, Link 1-3 and Link 1-4 to obtain an aggregate link. As a result, with respect to CORE device #1, ports of the CORE device #1 on which Link1-1-1, Link1-1-2, Link2-1, Link3-1 and Link4-1 are distributed are the local aggregate member ports of the CORE device #1.

In the present example, the local aggregate member ports of each CORE device can be called effective aggregate member ports.

Block 202: recording information of connection between each CORE device in the stack system and its peer ACCESS devices.

Block 202 may be implemented at the initial stage.

In block 202, recording information of connection between each CORE device in the stack system and its peer ACCESS devices comprises: recording information of connection between each CORE device in the stack system and its peer ACCESS devices through the local aggregate member ports. Here, if the information of connection between one CORE device and one of its peer ACCESS devices is recorded, it would mean that said CORE device is in effective connection with said peer ACCESS device currently.

Still taking the networking of FIG. 1 as an example, suppose that the CORE device #1 has the following aggregate member ports locally: a port (which is called aggregate member port 1) of the CORE device #1 on which a member link Link1-1 of Agg1 is distributed, a port (which is called aggregate member port 2) of the CORE device #1 on which a member link Link2-1 of Agg2 is distributed, and a port (which is called aggregate member port n) of the CORE device #1 on which a member link Linkn-1 of Aggn is distributed, then in this block 202, recording that the CORE device #1 is in effective connection with the ACCESS device #1 through the aggregate member port 1, recording that the CORE device #1 is in effective connection with the ACCESS device #2 through the aggregate member port 2, and recording that the CORE device #1 is in effective connection with the ACCESS device #n through the aggregate member port n.

As mentioned above, each ACCESS device may have more than one link connection with a same CORE device depending on the bandwidth requirement, so in said block 202, as long as one of the links between the CORE device and the ACCESS device is in effective connection, the information of connection between said CORE device and said ACCESS device will be recorded.

Block 203: upon determining a change in the information of connection between any CORE device and its peer ACCESS devices, labeling said CORE device with a low-forwarding-capability identifier and controlling any ACCESS device, when transmitting a message, to select a CORE device from other CORE devices than said CORE device labeled with a low-forwarding-capability identifier to perform message forwarding.

In said block 203, determining a change in the information of connection between any CORE device and its peer ACCESS devices includes:
comparing the recorded information of connection between said CORE device and its peer ACCESS devices to the current information of connection between said CORE device and its peer ACCESS devices;
if they are the same, it shows that the information of connection between said CORE device and its peer ACCESS devices has not changed;
if they are not the same, it is determined that the information of connection between said CORE device and its peer ACCESS devices changes when at least one peer ACCESS device which has been effectively connected to said CORE device disconnects from said CORE device.

Moreover, in said block 203, controlling any ACCESS device, when transmitting a message, to select a CORE device from other CORE devices than said CORE device labeled with a low-forwarding-capability identifier to perform message forwarding may include:
Block 1: searching the recorded local aggregate member ports of all CORE devices for local aggregate member ports of the CORE device labeled with a low-forwarding-capability identifier;
Block 2: determining each of the searched ports as a non-selected port and controlling a port of an ACCESS device on which a member link connected to the non-selected port is distributed to be a non-selected port, so that any ACCESS device, when transmitting a message, can locally select a port other than the non-selected port to transmit the message. Here, through making any ACCESS device, when transmitting a message, to locally select a port other than the non-selected port to transmit the message, it is possible to ensure that any ACCESS device, when transmitting a message, can select a CORE device from other CORE devices than the CORE device labeled with a low-forwarding-capability identifier to perform message forwarding.

In addition, since the stack system and an ACCESS device are connected through an aggregate link, there is a port for said aggregate link at the ACCESS device side, which is called an aggregate port, and said aggregate port is virtual and includes ports (which are called member ports) of the ACCESS device on which member links in said aggregate link are distributed. Likewise, there is another port for said aggregate link at the stack system side, which is also called an aggregate port, and said aggregate port also includes ports (which are also called member ports) of CORE devices of the stack system on which the member links in said aggregate link are distributed. These two aggregate ports are ports at the two ends of one and the same aggregate link, and they are of one-to-one correspondence.

Thus, if each ACCESS device in the data center network is connected to the stack system through an aggregate link, then each ACCESS device has an aggregate port thereon, and the stack system has N aggregate ports thereon, N being the number of the ACCESS devices. Therefore, in the above-mentioned block 2, determining each of the searched ports as a non-selected port and controlling a port of an ACCESS device on which a member link connected to the non-selected port is distributed to be a non-selected port may specifically include:
labeling each of the searched ports with an aggregate non-selected identifier;
notifying the aggregate port where the port labeled with an aggregate non-selected identifier locates;
upon receiving a notice, the aggregate port determining the port labeled with an aggregate non-selected identifier to be a non-selected port, and triggering its corresponding peer aggregate port to determine a corresponding member port (i.e. a port of an ACCESS device on which a member link connected to the non-selected port is distributed) to be a non-selected port according to an aggregate protocol mechanism. The aggregate protocol mechanism is specifically that when an aggregate port determines one of its member ports to be a non-selected port, the peer aggregate port corresponding to said aggregate port in one-to-one correspondence will also determine its corresponding member port having connection to said determined non-selected port to be a non-selected port.

So far, the flow shown in FIG. 2 is completed. Now the flow shown in FIG. 2 will be described using a specific example.

Taking CORE device #1 in the networking shown in FIG. 1 as an example, suppose that ACCESS device #1, ACCESS device #2 and ACCESS device #n are connected to the stack system through aggregate link 1 (labeled as Agg1), aggregate link 2 (labeled as Agg2) and aggregate link 3 (labeled as Aggn), then in the initial stage, as shown in FIG. 1, the CORE device #1 has the following aggregate member ports thereon: a port (which is called aggregate member port 1) of CORE device #1 on which the member link Link 1-1 in Agg1 is distributed, a port (which is called aggregate member port 2) of CORE device #1 on which the member link Link 2-1 in Agg2 is distributed, and a port (which is called aggregate member port n) of CORE device #1 on which the member link Link n-1 in Aggn is distributed, besides, the CORE device #1 is in effective connection to the ACCESS device #1 through the aggregate member port 1, to ACCESS device #2 through the aggregate member port 2, and to ACCESS device #n through the aggregate member port n. In this initial stage, an ACCESS device can forward traffic according to HASH algorithm, and in order to avoid transmission of traffic across CORE devices, a Core device in the stack system forwards traffic in the manner of local preference forwarding. As shown in FIG. 1, when ACCESS device #n forwards traffic to ACCESS device #1 through the stack system, first, the ACCESS device #n selects a member link from the aggregate link

Aggn (consisting of Link n-1˜Link n-4 through which ACCESS device #n is connected to Core device #1˜Core device #4, respectively) between the ACCESS device #n and the stack system using the HASH algorithm to send traffic to the stack system, suppose that the member link selected by ACCESS device #n is Link n-1, then Core device #1 in the stack system will receive traffic sent by ACCESS device #n. Upon receiving the traffic sent by ACCESS device #n, Core device #1 forwards said received traffic to ACCESS device #1 through Link 1-1 connecting to ACCESS device #1 in the manner of local preference forwarding.

However, if the ACCESS device #1 disconnects from the CORE device #1, then based on the flow shown in FIG. 2, it is needed to label the CORE device #1 with a low-forwarding-capability identifier and determine all aggregate member ports, i.e. aggregate members 1, 2 and n on said CORE device #1 to be non-selected ports; meanwhile, determine ports of ACCESS devices on which member links connected to the non-selected ports are distributed, namely, a port of ACCESS device #1 on which the member link Link 1-1 in Agg1 is distributed, a port of ACCESS device #2 on which the member link Link 2-1 in Agg2 is distributed, and a port of ACCESS device #n on which the member link Link n-1 in Aggn is distributed, as the non-selected ports. In this case, the ACCESS device #1, #2 or #n will forward messages through other local ports than the non-selected ports, which ensures that no message will be sent to CORE device #1. Since the CORE device #1 does not receive any message, even if the information of connection between said CORE device #1 and its peer ACCESS devices changes, the increasing of load on inter-chassis link caused by the CORE device #1 forwarding traffic through an inter-chassis link between CORE devices can be avoided, and the traffic forwarding performance can be improved.

The method according to an example of the present disclosure is described in the above. Now the apparatus according to an example of the present disclosure will be described.

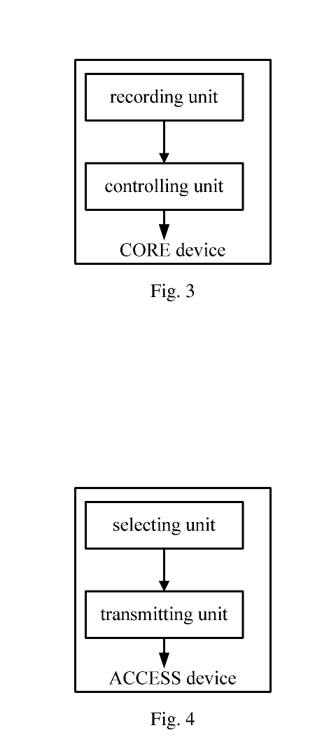

Referring to FIG. 3, which is a CORE device provided by an example. Said CORE device and all other CORE devices form a stack system through stacking; as shown in FIG. 3, said CORE device comprises:
a recording unit to record information of connection between said CORE device and its peer ACCESS devices;
a controlling unit to, upon determining a change in the information of connection between the CORE device and its peer ACCESS devices, label said CORE device with a low-forwarding-capability identifier and control any ACCESS device, when transmitting a message, to select a CORE device from other CORE devices than said CORE device labeled with a low-forwarding-capability identifier to perform message forwarding.

In the present example, said recording unit further records the local aggregate member ports of the CORE device. The local aggregate member ports of the CORE device include a port of the present CORE device on which a member link in an aggregate link between the stack system and any ACCESS device is distributed. Thus the recording unit recording information of connection between the CORE device in the stack system and its peer ACCESS devices includes: recording information of connection of the CORE device in the stack system and its peer ACCESS devices through local aggregate member ports.

In the present example, a change in the information of connection between said CORE device and its peer ACCESS devices includes that the connection between the CORE device and its peer ACCESS devices via the local aggregate member ports is disconnected.

In the present example, the controlling unit controlling any ACCESS device, when transmitting a message, to select a CORE device from other CORE devices than said CORE device labeled with a low-forwarding-capability identifier to perform message forwarding includes:
searching the recording unit for the local aggregate member ports of the CORE device labeled with a low-forwarding-capability identifier and determining them to be non-selected ports;
controlling a port of a ACCESS device on which a link connected to each of the non-selected ports is distributed to be a non-selected port, so that any ACCESS device, when transmitting a message, locally selects a port other than the non-selected port to transmit the message.

Referring to FIG. 4, which is a structural diagram of an ACCESS device provided by an example. As shown in FIG. 4, said ACCESS device comprises:
a selecting unit to select a CORE device from other CORE devices than the CORE device labeled with a low-forwarding-capability identifier when transmitting a message, wherein a CORE device is labeled with a low-forwarding-capability identifier when determining a change in the information of connection between the CORE device and its peer ACCESS devices;
a transmitting unit to forward a message to the selected CORE device.

It can be seen from the above technical solutions that in the present disclosure, when the information of connection between any CORE device and its peer ACCESS devices changes, said CORE device is labeled with a low-forwarding-capability identifier and any ACCESS is controlled, when transmitting a message, to select a CORE device from other CORE devices than said CORE device labeled with a low-forwarding-capability identifier to perform message forwarding, thus the CORE device which has a change in the information of connection to its peer ACCESS devices will not receive any message, and accordingly, the increasing of load on the inter-chassis link caused by using the inter-chassis link between the CORE devices to perform traffic forwarding can be avoided and the traffic forwarding performance can be improved.

The above examples can be implemented by hardware, software or firmware or a combination thereof. For example the various methods, processes and functional modules described herein may be implemented by a processor (the term processor is to be interpreted broadly to include a CPU, processing unit, ASIC, logic unit, or programmable gate array etc.). The processes, methods and functional modules may all be performed by a single processor or split between several processers; reference in this disclosure or the claims to a ‘processor’ should thus be interpreted to mean ‘one or more processors’. The processes, methods and functional modules be implemented as machine readable instructions executable by one or more processors, hardware logic circuitry of the one or more processors or a combination thereof. Further the teachings herein may be implemented in the form of a software product. The computer software product is stored in a storage medium and comprises a plurality of instructions for making a computer device (which can be a personal computer, a server or a network device such as a router, switch, access point etc.) implement the method recited in the examples of the present disclosure.

While the present disclosure describes various examples, these examples are to be understood as illustrative and do not limit the claim scope. Many variations, modifications, additions and improvements of the described examples are possible. All such variations, modifications, additions and improvements are within the scope of the present disclosure.

1. A message forwarding method in a data center network, said data center network comprising CORE devices and ACCESS devices, wherein the CORE devices form a stack system through stacking, wherein said method comprises:
recording information of connection between each CORE device in the stack system and its peer ACCESS devices;
upon determining a change in the information of connection between any CORE device and its peer ACCESS devices, labeling said CORE device with a low-forwarding-capability identifier and controlling any ACCESS device, when transmitting a message, to select a CORE device other than said CORE device labeled with a low-forwarding-capability identifier to perform message forwarding.

2. The method according to claim 1, wherein said method further comprises:
recording local aggregation member ports of each of the CORE devices in the stack system, the local aggregate member ports of a CORE device include a port of said CORE device on which a member link in an aggregate link between the stack system and any ACCESS device is distributed;
said recording information of connection between each CORE device in the stack system and its peer ACCESS devices comprises: recording information of connection between each CORE device in the stack system and its peer ACCESS devices via the local aggregate member ports.

3. The method according to claim 2, wherein a change in the information of connection between a CORE device and its peer ACCESS devices includes that the connection between the CORE device and its peer ACCESS devices via the local aggregate member ports is disconnected.

4. The method according to claim 2, wherein said controlling any ACCESS device, when transmitting a message, to select a CORE device from other CORE devices than said CORE device labeled with a low-forwarding-capability identifier to perform message forwarding includes:
searching the recorded local aggregate member ports of the CORE devices for local aggregate member ports of the CORE device labeled with a low-forwarding-capability identifier;
determining the searched local aggregate member ports of the CORE device labeled with a low-forwarding-capability identifier as non-selected ports;
controlling a port of an ACCESS device on which a member link connected to each of the non-selected ports is distributed to be a non-selected port, so that any ACCESS device, when transmitting a message, locally selects a port other than the non-selected port to transmit the message.

5. A CORE device for use in a data center network, said CORE device being capable of forming a stack system together with other CORE devices, wherein said CORE device comprises:
a recording unit to record information of connection between said CORE device and its peer ACCESS devices;
a controlling unit to label said CORE device with a low-forwarding-capability identifier upon determining a change in the information of connection between said CORE device and its peer ACCESS devices, and control any ACCESS device, when transmitting a message, to select a CORE device other than said CORE device labeled with a low-forwarding-capability identifier to perform message forwarding.

6. The CORE device according to claim 5, wherein said recording unit is further to record local aggregate member ports of the CORE device, and the local aggregate member ports of the CORE device include a port of the CORE device on which a member link in an aggregate link between the stack system and any ACCESS device is distributed;
the recording unit is to: record information of connection of the CORE device in the stack system and its peer ACCESS devices through the local aggregate member ports.

7. The CORE device according to claim 6, wherein a change in the information of connection between the CORE device and its peer ACCESS devices includes that the connection between the CORE device and its peer ACCESS devices via the local aggregate member ports is disconnected.

8. The CORE device according to claim 6, wherein the controlling unit is to:
determine the local aggregate member ports of the CORE device labeled with a low-forwarding-capability identifier recorded in the recording unit to be non-selected ports;
and control a port of a ACCESS device on which a link connected to each of the non-selected ports is distributed to be a non-selected port, so that any ACCESS device, when transmitting a message, locally selects a port other than the non-selected port to transmit the message.

9. An ACCESS device for use in a data center network which comprises CORE devices which are stacked together to form a stack system through stacking, said ACCESS device comprising:
a selecting unit to select a CORE device from other CORE devices than the CORE device labeled with a low-forwarding-capability identifier when transmitting a message, wherein a CORE device is labeled with a low-forwarding-capability identifier when determining a change in the information of connection between the CORE device and its peer ACCESS devices;
a transmitting unit to forward a message to the selected CORE device.
